(19) United States
(12) Patent Application Publication
(10) Pub. No.: US 2012/0260254 A1
(43) Pub. Date: Oct. 11, 2012

(54) VISUAL SCRIPTING OF WEB SERVICES FOR TASK AUTOMATION

(75) Inventors: Li Chen, Cary, NC (US); John R. Hind, Raleigh, NC (US); Yongcheng Li, Cary, NC (US); Lun Xiao, Cary, NC (US)

(73) Assignee: INTERNATIONAL BUSINESS MACHINES CORPORATION, Armonk, NY (US)

(21) Appl. No.: 13/524,113

(22) Filed: Jun. 15, 2012

Related U.S. Application Data
(63) Continuation of application No. 11/693,284, filed on Mar. 29, 2007.

(51) Int. Cl. G06F 9/46

(52) U.S. Cl. 718/102

(57) ABSTRACT

Tasks are automated using assemblies of services. An interface component allows a user to collect services and to place selected services corresponding to a task to be automated onto a workspace. An analysis component performs an analysis of available data with regard to the selected services provided on the workspace and a configuration component automatically configures inputs of the selected services based upon the analysis of available data without intervention of the user. A dialog component is also provided to allow the user to contribute information to configure one or more of the inputs of the selected services. When processing is complete, an output component outputs a script that is executable to implement the task to be automated.

### CROSS REFERENCE TO RELATED APPLICATIONS

This application is a continuation of U.S. patent application Ser. No. 11/693,284, entitled Visual Scripting of Web Services for Task Automation, filed Mar. 29, 2007, the entire disclosure of which is incorporated by reference herein.

### BACKGROUND

The present invention relates to systems, computer-implemented methods and computer program products for providing task automation.

Advancing computer technology is enabling many organizations to move towards a service oriented architecture where the data flows and business logic of the organization are implemented using assemblies of web services. In general, web services are software components capable of being accessed via standard network protocols using a standardized messaging system. Such web services are typically capable of exchanging data with software applications that are written in various programming languages running on various platforms, thus enabling platform independent implementations of the organization's data flows and business logic.

In practice, an individual may utilize a web services application programming interface (API) or other appropriate programming tool to define and implement an organization's business processes. As an example, the web services API may be utilized to specify flows of information corresponding to a process, e.g., to automate a daily task. The web services API transforms the specified flows of information into a corresponding composition application, which utilizes selected web services where each web service implements an associated subpart of the process, such as by performing associated functions, roles, actions and/or processes, corresponding to the specific flows.

However, programming skills and knowledge are required to assemble composition applications using available software tools, such as conventional web services APIs. As such, it is challenging for ordinary people, especially those without programming skills, to automate their daily tasks based on their needs using such conventional technologies.

### BRIEF SUMMARY

According to an aspect of the present invention, a computer-implemented method for automating tasks using assemblies of services comprises providing an interface component that allows a user to collect services and to place selected services corresponding to a task to be automated onto a workspace. The method further comprises providing an analysis component that performs an analysis of available data with regard to the selected services, providing a configuration component to automatically configure inputs of the selected services based upon the analysis of available data without intervention of the user and providing a dialog component to allow the user to contribute information to configure one or more of the inputs of the selected services. The method still further comprises providing an output component that outputs a script that is executable to implement the task to be automated.

### BRIEF DESCRIPTION OF THE SEVERAL VIEWS OF THE DRAWINGS

FIG. 1 is a schematic illustration of an exemplary system in which scripting of services for task automation may be implemented according to an aspect of the present invention;

FIG. 2 is a block diagram of an exemplary system model for implementing a scripting tool according to an aspect of the present invention;

FIG. 3 is a flow chart illustrating an exemplary processing flow for scripting services for task automation according to an aspect of the present invention;

FIG. 4 is a flow chart illustrating an exemplary implementation of a script run-time for assembling services for task automation according to an aspect of the present invention;

FIG. 5 is a block diagram of an exemplary arrangement of system components for implementing the flow of FIG. 3 according to an aspect of the present invention;

FIG. 6 is a block diagram illustrating an exemplary approach for visually selecting services onto a palette according to an aspect of the present invention; and

FIG. 7 is a block diagram illustrating an exemplary implementation of a template and corresponding data flow graph according to an aspect of the present invention.

### DETAILED DESCRIPTION

The various aspects of the present invention may be embodied as systems, computer-implemented methods and computer program products. Also, various aspects of the present invention may take the form of an entirely hardware embodiment, an entirely software embodiment (including firmware, resident software, micro-code, etc.) or an embodiment combining software and hardware, wherein the embodiment or aspects thereof may be generally referred to as a “circuit,” “component” or “system.” Furthermore, the various aspects of the present invention may take the form of a computer program product on a computer-usable storage medium having computer-usable program code embodied in the medium.

The software aspects of the present invention may be stored, implemented and/or distributed on any suitable computer usable or computer readable medium(s), including but not limited to, any medium that can contain, store, communicate, propagate or transport the program for use by or in connection with an instruction execution system of a corresponding processing device. The computer program product aspects of the present invention may have computer usable or computer readable program code portions thereof, which are stored together or distributed, either spatially or temporally across one or more devices. A computer-usable or computer-readable medium may comprise, for example, an electronic, magnetic, optical, electromagnetic, infrared, or semiconductor system, apparatus, device, or propagation medium.

More specific examples of the computer usable or computer readable medium comprise for example, an electrical connection having one or more wires, a swappable intermediate storage medium such as floppy drive, tape drive, external hard drive, a portable computer diskette, a hard disk, a random access memory (RAM), a read-only memory (ROM), an erasable programmable read-only memory (EPROM or Flash memory), a portable compact disc read-only memory (CD-ROM) or digital video disk (DVD), an optical fiber or storage device, or a transmission media such as those supporting the Internet or an intranet. The computer-usable or computer-readable medium may also comprise paper or another suitable medium upon which the program is printed, as the program can be electronically captured, for example, via optical scanning of the paper or other medium, then compiled, interpreted, or otherwise processed in a suitable manner, if necessary, and then stored in a computer memory. The computer-usable medium may include a propagated data signal with the computer-usable program code embodied therewith, either in baseband or as part of a carrier wave or a carrier signal. The computer usable program code may also be transmitted using any appropriate medium, including but not limited to the Internet, wire line, wireless, optical fiber cable, RF, etc.

Computer program code for carrying out operations of the present invention may be written in any suitable language, including for example, an object oriented programming language such as Java, Smalltalk, C++ or the like. The computer program code for carrying out operations of the present invention may also be written in conventional procedural programming languages, such as the “C” programming language, or in higher or lower level programming languages. The program code may execute entirely on a single processing device, partly on one or more different processing devices, as a stand-alone software package or as part of a larger system, partly on a local processing device and partly on a remote processing device or entirely on the remote processing device. In the latter scenario, the remote processing device may be connected to the local processing device through a network such as a local area network (LAN) or a wide area network (WAN), or the connection may be made to an external processing device, for example, through the Internet using an Internet Service Provider.

According to an aspect of the present invention, a scripting tool is provided, that allows users to locate and add services to a workspace, such as a service palette. The tool automatically organizes (“wires”) the services that are selected, e.g., that are dragged or otherwise added to the service palette. The tool further creates a dialog with the user to resolve any information required to configure the services selected to the palette, and to present the user with an opportunity to customize of otherwise modify default parameters that were automatically selected by the tool. For example, the tool may suggest using information which is derived from service definitions corresponding to the selected services as defaults in the dialog. The script will then appropriately organize the user accepted and user identified service execution elements.

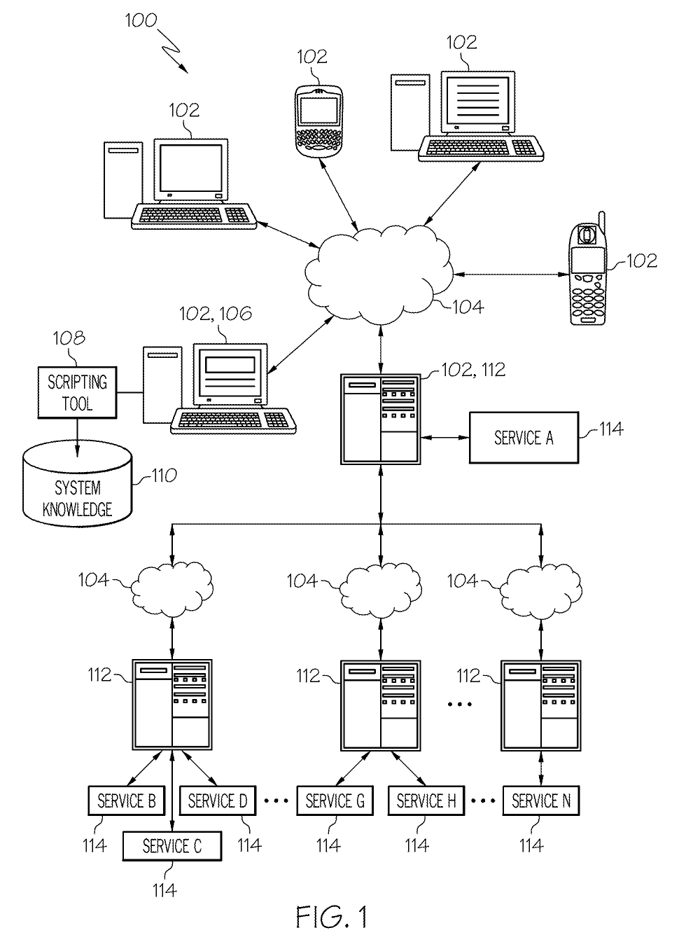

Referring now to the drawings and particularly to FIG. 1, an exemplary system 100 is illustrated in which scripting of services for task automation may be implemented according to an aspect of the present invention. The system 100 includes a plurality of processing devices 102 that communicate across a network system 104. The processing devices 102 may comprise four example, servers, personal computers, notebook computers, transactional systems, appliance or pervasive computing devices such as personal data assistants (PDA), palm computers, cellular access processing devices, special purpose computing devices and/or other devices capable of interacting with the system 100, and may thus be implemented in hardware, software, or a combination of hardware and software.

The various processing devices 102 may be supported by networking components such as routers, hubs, firewalls, network interfaces, wired or wireless communications links and corresponding interconnections. Moreover, the network system 104 may comprise one or more intranets, extranets, local area networks (LAN), wide area networks (WAN), wireless networks (WIFI), the Internet, including the World Wide Web, and/or other arrangements for enabling communication between the processing devices 102, either real time or otherwise, e.g., via time shifting, batch processing, etc.

In an illustrative example, a selected one of the processing devices 102, further designated by the reference numeral 106, may execute a scripting tool 108 for task automation. Further, the scripting tool 108 may utilize system knowledge 110 for performing task automation functions, as will be described in greater detail below. The scripting tool 108 and system knowledge 110 are schematically illustrated as being associated with the processing device 106, but each may reside anywhere practical, e.g., either physically on the processing device 106 or on a device that can be brought into data communication with the processing device 106, such as across the network system 104. For example, if the processing device 106 is part of a business network, the scripting tool 108 and/or system knowledge 110 may be stored on a corresponding business server, etc. The scripting tool 108 and/or the system knowledge 110 may also be distributed across one or more processing devices 102 that are capable of data communication with the processing device 106, e.g., via the network system 104.

The processing device 106 may also be part of a computer enterprise, which may consist of, or otherwise be in data communication with, a community that utilizes loosely coupled and typically independent software services to support the requirements of business processes and software users, such as in a “service oriented architecture” (SOA). For purposes of illustration, the processing device 106 may be part of a network that includes one or more servers 112, such as business servers that each host one or more services 114, e.g., defining a set of available services, labeled Service A-Service N. Each service 114 is able to implement at least one function, role, action, computation or other defined process that may be utilized by one or more business processes. To automate a task, such as a business process, the scripting tool 108 is utilized to build a composite application by assembling one or more services 114 from the set of available services configured such that execution of the composite application implements a flow of information defined by the corresponding task.

In an exemplary implementation, the services 114 comprise web services. Web services are typically designed to support interoperable machine to machine interaction over a network where the web service is stored and executed on a remote system that communicates with the requesting system, e.g., using Simple Object Access Protocol (SOAP)-formatted extended markup language (XML) commands Thus, for example, a composition application built by the scripting tool 108 executed on the processing device 106 may utilize multiple web services 114, e.g., Service A, Service C and Service N, which are each physically stored and executed on their corresponding server 112. As such the composition application built by the scripting tool 108 may be required to communicate with multiple, potentially independent servers 112.

As a simplified, yet illustrative example, in a dentist office, there are a couple of tasks that a dental receptionists may be required to complete after each patient visit, including collecting a payment or co-payment where insurance is involved, scheduling the next appointment for the patient and filing a claim with the patient's insurance company where necessary. Additionally, the patients have to keep the receipts for their Flexible Spending Account (FSA) reimbursement, receipts and/or other relevant information with regard to their visit to the dental office.

Conventionally, the above-described tasks may be performed manually, electronically, or by a combination of manual and electronic processes. Moreover, each step of the task may be implemented on separate systems, e.g., by manually providing a receipt for a co-pay using a printout generated from an accounting application, by manually scheduling the next appointment on a paper or electronic calendar application, and by manually filing the insurance claim (where necessary) using yet another application and/or manual process. Moreover, the steps involved in these tasks may be repeated many times everyday. As such, automation of these tasks will likely greatly improve work efficiency and productivity.

Also, since many people see their dentist frequently, e.g., on a regular quarterly or semiannual basis for cleaning and checkups, an opportunity exists for the dentist to collect historical data with regard to individual patients as well as classes of patient. However, many workers do not possess the requisite applications development skills to build composition applications to implement the work flows corresponding to tasks that would benefit from automation. As such, numerous opportunities may be missed to collect useful information and/or to improve the efficiency of workflow.

According to aspects of the present invention, ordinary people, without any programming skills may automate their tasks through visual scripting. Thus for example, the dental office receptionist, who understands the tasks to be automated but who may not possess the technical computer skills and proficiency to automate the workflow using conventional approaches, may build composition applications that automate such tasks. By manipulating (locating, assembling, configuring, testing, etc.,) web services in a graphical environment as described in greater detail herein, non-programmer users can automate their tasks by running automatically generated web service scripts. Thus, for example, using the visual scripting tool 108 described more fully herein, the dental receptionist can generate scripts that implement the above-described tasks without the need to possess programming experience or understand program code.

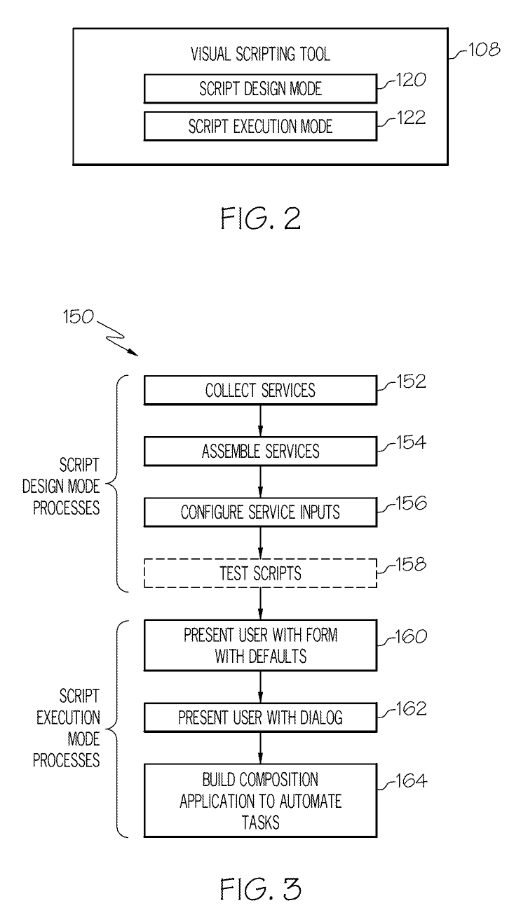

Referring to FIG. 2, according to an aspect of the present invention, the visual scripting tool 108 may be logically divided into two stages including a script design mode 120 and script execution mode 122. In the script design mode 120, activities are performed to organize a corresponding process, information flow, etc., into a script. The script execution mode 122 may then be utilized to execute instances of the designed script.

Referring to FIG. 3, a flow chart 150 illustrates a process implemented by the scripting tool 108 for task automation. Services are collected at 152. In order to collect services at 152, the scripting tool allows a user to search for and/or identify services 114 that are related to the task to be automated for the user. For example, when building applications that utilize web-based services, certified registers may be searched, e.g., by the scripting tool 108 or otherwise, for published services that correspond to the task or a task subpart to be automated. As an example, the Universal Description, Discovery, and Integration (UDDI) registry, which is defined by UDDI.org, provides a platform-independent, XML-based registry for businesses and supports client interfaces based on Simple Object Access Protocol (SOAP) requests. The UDDI registry is used by web services providers to register the web services that they provide, and to publish data about their registered web services so that users can obtain corresponding implementation details. The scripting tool 108 may utilize other public and/or private registries in addition to, or in lieu of using the UDDI registry.

In addition to being registered, the commands, inputs and other interfacing requirements of at least some of the services 114 in the set of available services may comply with some form of standardization. Under this arrangement, all services 114 that implement a specific function, where that function is defined by an associated standard, may support the same set of interfacing requirements, thus further facilitating an effective approach for searching and/or otherwise identifying appropriate services 114 for automating tasks.

If no services could be located that meet the user's searching criteria, e.g., that corresponds to a particular aspect of the task to be automated, the user can modify the search and try again. If the user is satisfied that there are no available services that can implement the corresponding aspect of the desired task, the user may submit a request with a detailed description of the desired service, e.g., to one or more of the registers. As such, if and when a service is identified that meets the user's requirements, then that service can be provided to the user.

Selected services are collected by the user at 154. Depending upon the specific environment, the manner in which the user selects the services 114 corresponding to the task to be automated may vary. For example, in a visual scripting environment, the user may accumulate the selected services onto a workspace. As an illustrative example, the user may simply “drag” and “drop” the selected services onto a service palette. The term “service palette” is used in a general sense to comprise any mechanism, visual, logical or otherwise that distinguishes the selected services in a workspace so that the selected services can be identified and associated with a process to be automated.

Service inputs are configured at 156. In this regard, the scripting tool 108 analyzes the selected services 114, e.g., the services 114 that were dragged onto the service palette by the user. The scripting tool 108 also automatically organizes the services in a sequence so as to minimize user inputs needed to accomplish the overall task of data collection.

As an example, the scripting tool 108 may create a data flow graph representing the selected services. In this regard, the scripting tool 108 analyzes the selected services to determine the order in which the selected services must be assembled and automatically “wires” or connects the services together, e.g., based upon the known or detectable interfacing requirements of the selected services. As such, the user is not asked to “wire” or “connect” the selected services. The user needs to possess the knowledge to carry out the task to be automated. However, the user does not need to possess programming knowledge, or even the knowledge required to “wire” or interconnect the selected services 114. That is, the user may comprise an ordinary person with no code writing/programming skills or application development/programming language knowledge, who would like to automate their daily repeated tasks. This can be seen because the user may not be required to set up the order of the services, understand the interfacing requirements of the selected services, etc.

The scripting tool 108 may also create a dialog from the data flow graph where fields containing input data values may be expressed as selection lists, e.g., in a most likely to least likely order of service results. Alternatively, the input data value fields may define user inputs that are needed to satisfy the corresponding service interfacing requirements. User actions may also be utilized to configure script execution, for example, by setting defaults for service interfacing requirements or by setting service execution constraints, e.g., specifying an input should be taken from another service output, etc.

Script testing may optionally be implemented at 158. For example, certain services 114 may provide testing scripts to test interaction with the corresponding service 114. As such, one or more of the selected services 114 may provide a testing function so that the user can test and further refine the selection of services and/or service inputs.

The user is presented with a form at 160, which displays or otherwise indicates to the user, the default values that were automatically generated to assemble the selected services. The form may also display, where applicable, a listing of the multiple choices associated with a field of information. Still further, fields may be identified where no information could be automatically generated, such as where user intervention is required to complete missing information.

The user is presented with a dialog at 162 to supply missing information, change default values, select specific values for a given field, such as where multiple options may have existed, etc. A composition application is then built at 164, which is based upon the user selected services and user authorized inputs, but which has been automatically “wired” by the scripting tool 108 to automate the associated task.

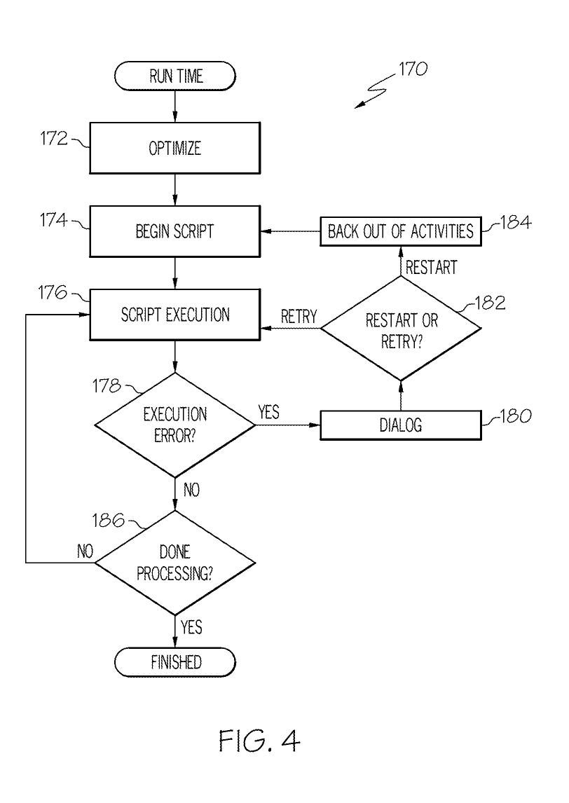

Referring to FIG. 4, an exemplary flow of a run-time process 170 is illustrated, e.g., corresponding to the script execution mode 122 shown in FIG. 2. The script execution, which may be implemented for example, by a script engine, performs an optimization at 172. For example, at run time, a design mode “template” may be used to present the user with a form that shows the inputs of the selected services, e.g., services that have been dragged onto the service palette. In one exemplary implementation, the inputs are organized within the template from most likely to require data input from the user to least likely to require input from the user. The determination of whether it is likely that user input may be required, can be based upon any number of factors, including for example, the availability of template defined defaults, which may include historical knowledge of the past use of the corresponding service. For example, as will be described in greater detail below, script execution may comprise the analysis of possible patterns based upon past user inputs to suggest candidate inputs for default values provided in the template or other implementation of a form so that automatic execution can be carried out.

The script is initiated at 174 and the first task of the script is executed at 176. If a script execution error is detected at 178, then the script presents a dialog at 180 so that the user can correct the error. Exemplary errors may comprise, for example, where default data is not available for a given service interface requirement or where it is found that a selection from multiple possibilities is required that cannot automatically be resolved by the tool 108. After the user corrects the condition that caused the error, the user may decide at 182 to retry the script. If the script is restarted, the process flow jumps back to the task being processed by the script execution at 176. Alternatively, the user may decide to restart the script, in which case the process may need to back out of all previous task activities at 184 and return flow back to the beginning of the script at 174.

If the decision is made at 178 that there were no errors in processing, a decision is made at 186 as to whether the script has completed. If not, flow resumes to the script execution at 176 to execute the next aspect of the script. If a decision is made at 186 that the script has completed, the process is finished. The result may comprise, for example, a composition application that implements the process flows associated with the corresponding task to be automated.

For each script execution, the user may specify either to step through each task execution at 176 before starting the next task, or the scripting tool 108 may execute all tasks in an overlapping mode, e.g., within the constraint of the relationships defined in a corresponding data flow graph.

Thus, an arbitrary collection of web services chosen by the end user are organized for execution, i.e., wired, by a data flow analysis. The tool coalesces the requirement inputs of the selected web services and presents the determined results in a suitable format, e.g., ordered lists presented in a graphical user interface. Thus, the user resolves conflicts by choosing from default or user provided values to satisfy the possible sources for each input item in the ordered lists. Based upon the data flow, a script is generated for runtime execution.

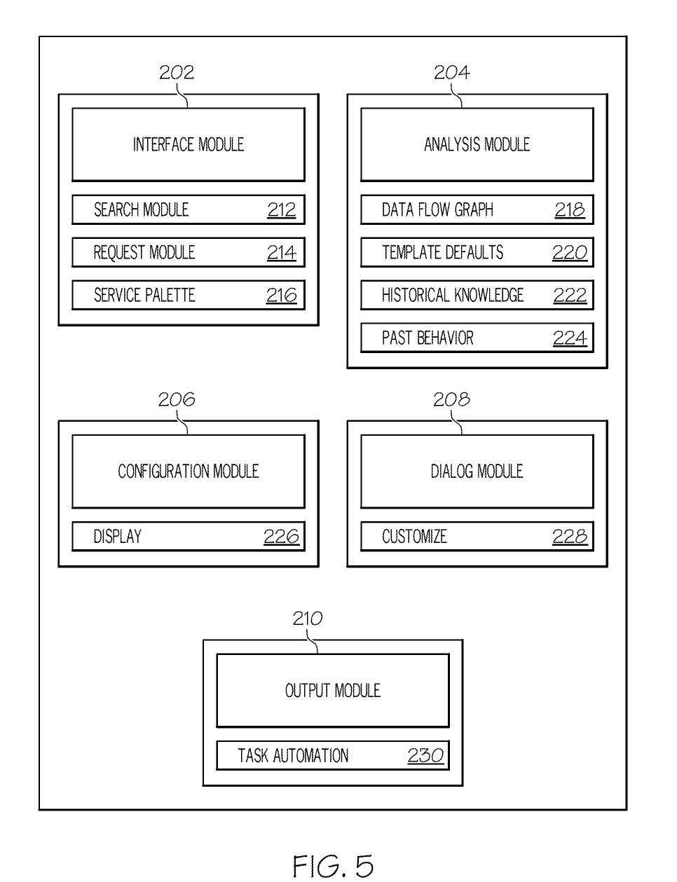

Referring to FIG. 5, the scripting tool 108 may be implemented, either conceptually or logically as a plurality of components, including an interface component 202, an analysis component 204, a configuration component 206, a dialog component 208 and an output component 210. The interface component 202 may include for example, a search component 212, a request component 214 and a service palette 216.

The search component 212 implements a search tool and corresponding interface that allows a user to search for services 114, e.g., locally or across a network, using private and/or publicly available resources. The request component 214 implements a request tool and corresponding interface that allows a user to request services that could not otherwise be located. If a service is identified that can satisfy the requirements of the request, then that service may be made known to the user.

The selected services 114, e.g., chosen by the user from interaction with the search component, request component or otherwise by the interface component 202, may be associated with a workspace, e.g., linked, added, dragged and dropped or otherwise placed onto a service palette that allows the user to visualize or otherwise identify the selected services. The interface component 202 may be used, for example, to implement the collection of services at 152 described with reference to FIG. 3.

The analysis component 204 may include for example, a data flow graph component 218, a template defaults component 220, a historical knowledge component 222 and a past behavior component 224. The analysis component 204 may be used, for example to implement the configuration of service inputs at 156 described with reference to FIG. 3.

The data flow graph component 218 constructs a data flow graph based upon the services added by the user onto the services palette, such as by organizing the selected services in a sequence so as to minimize any user inputs needed to accomplish the overall task of data collection to satisfy all of the service interface requirements.

The template defaults component 220 may be implemented, for example, by a script engine of the scripting tool 108 that analyzes available data, including for example, past user inputs, possible patterns, selected service information and/or other available knowledge including historical knowledge, statistically generated knowledge, computed or measured knowledge or other forms of information to suggest candidate inputs for default information where practical. The template defaults component 220 may also implement, or otherwise interact with the historical knowledge component 222 and/or past behavior component 224. As an example, the historical knowledge component 222 and/or past behavior component 224 may implement an interface to system knowledge, such as system knowledge 110 illustrated in FIG. 1. Further, the historical knowledge component 222 and/or past behavior component 224 may perform calculations, manipulations and other forms of processing and analysis to generate or assist in generating candidate inputs for default information.

The configuration component 206 may comprise a display component 226 that presents, for example, the services palette in a graphical environment and/or displays the default values that are generated by the script analysis engine of the scripting tool 108. The configuration component 206 may be used, for example to implement the form presentation at 160 described with reference to FIG. 3.

The dialog component 208 comprises a customize component 228. The customize component 228 may be used to implement a template, form or other manner of interacting with the user. The dialog component 208 may be used, for example to implement the user dialog at 160 described with reference to FIG. 3.

The customize component 228 may, for example, create a dialog from the data flow graph, such as by presenting input data value fields with selection lists and/or default values or blank values that require user contribution, such as to satisfy the service input data needs. For example the selection lists may represent fields in a most likely to least likely order of service results or with user inputs.

The dialog component allows user actions to configure the script execution both by setting defaults for service control inputs or setting service execution constraints by specifying an input should be taken from another service output. Thus, keeping with the dental office example, setting defaults for service control inputs may comprise, for example, defining the dentist office provider ID for a service that enters/processes insurance claims. As another example, setting service execution constraints may comprise, for example, defining the claim service policy ID that comes from the check-out patient record update service. The dialog component may also provide a script executable by the user, wherein the user may customize the script by setting defaults for service control inputs or by setting services execution constraints by specifying that an input from a first one of the selected services should be taken from an output of a second one of the selected services.

The output component 210 may comprise, for example, a task automation component 230 that outputs the composition application or other executable implementation of the corresponding task.

For example, assume that a task to be automated comprises scheduling a visit to a dentist office. A dental office employee, e.g., a receptionist, may use the interface component 202 to search for and to collect a scheduler service and a time analysis service into the workspace, e.g., by locating and dragging the above services onto a services palette. The scripting tool 108 analyzes each service that has been selected onto the palette. The scripting tool 108 may also optionally analyze any relevant extrinsic information, such as historical information and/or behavioral information, such as may be stored in the system knowledge 110, implementation specific information such as may be derived from one or more registries, user or system provided rules, policies, data, etc. The scripting tool 108 then uses the data flow graph component 218 to link a first selected service, e.g., the scheduler by appropriate interfacing data to a second selected service, e.g., the time analysis service that searches for free time. To the extent practical, the scripting tool 108 may use the available knowledge derived from its analysis to generate as many default inputs as possible. If user input is required to fill in some missing, incomplete, optional or otherwise ambiguous information, or if user authorization of generated inputs is desired, the scripting tool 108 may further generate a template or form that presents the generated defaults for user approval/editing and for user input of necessary information.

Assume that a patient, such as a school aged child now needs to schedule a time for a follow up visit after having a dental procedure performed. The dental office receptionist utilizes the script execution mode 122 of the scripting tool 108 to schedule the next appointment. Historical information, which may be stored in a database or other storage format, e.g., within the system knowledge 110 may be retrieved by the historical knowledge component 222 and is provided, for example, to the template defaults component 220. Likewise, past behavioral information, where applicable, and which may be stored in a database or other storage format, e.g., within the system knowledge 110 may be retrieved by the past behavior component 222 and is provided, for example, to the template defaults component 220. The template defaults component 220 analyzes the available data, including any weights, rules, policies, conditions, etc., and may conclude for example, that that for follow-up procedures, most patients schedule the first available time slot. The historical information may also reveal that appointments for school aged children are typically scheduled in late afternoon, after school is dismissed. As such, the template defaults component 220 may select a rule that selects the next available late afternoon time slot as a candidate default value time slot. As another illustrative example, it may be that the particular preferences for the patient over-ride more generally derived assumptions. Thus, for example, a school aged child may have a late afternoon scheduling conflict resulting from the working schedules of the child's parents. Accordingly, where most school aged children prefer late afternoons, it may be that a particular school aged child requires an appointment time on the weekends. Accordingly, for this patient, a default time slot may be the first available weekend time slot.

The above approach may be repeated for each field of information required to execute the corresponding script. After the dental receptionist approves the automatically generated inputs and/or provides necessary inputs and selections, the script is run, and the appointment is scheduled automatically by the associated services.

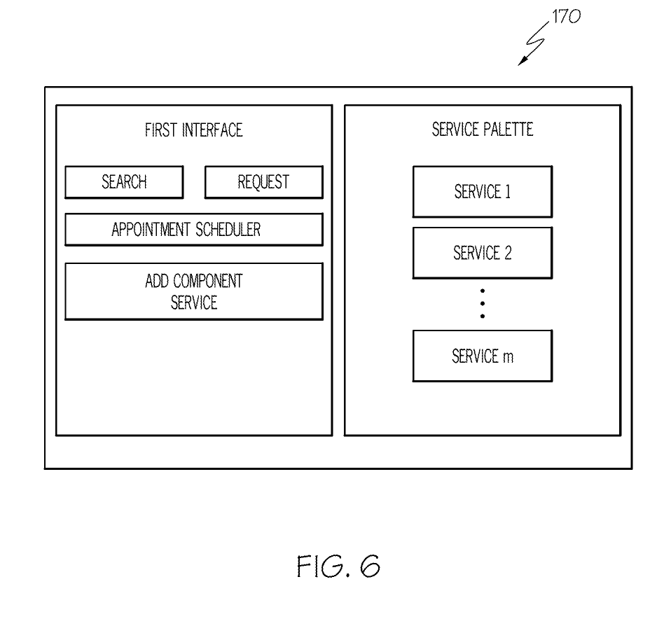

Referring to FIG. 6, an exemplary simplified screen illustrates a first user interface to the scripting tool 108, which includes tools to allow a user to search, request and collect selected services onto a workspace, e.g., a service palette as set out in greater detail herein. For example, as shown, the user has entered a search request for an appointment scheduler into the search feature. Moreover, as shown, the user has selected in services to the services palette. Although a service palette is illustrated for purposes of illustration, other visual approaches may alternatively be utilized. According to an aspect of the present invention, the user desirous to implement a process, such as to automate a business task, need not have knowledge of code writing or even of programming structure. Moreover, the user need not understand how to connect or wire together the selected services.

Rather, the user simply designates the selected services associated with the task to be automated. The analysis engine of the scripting tool 108 discovers how to connect the services, such as by identifying the interface requirements of each service, by matching service outputs to service inputs, etc. The analysis engine further generates candidate defaults to configure the services to the extent possible given the associated data available, which may include historical information and/or behavioral information. As such, minimal input from the user is required once the services are selected. Moreover, the information required of the user is consolidated into a unified user dialog.

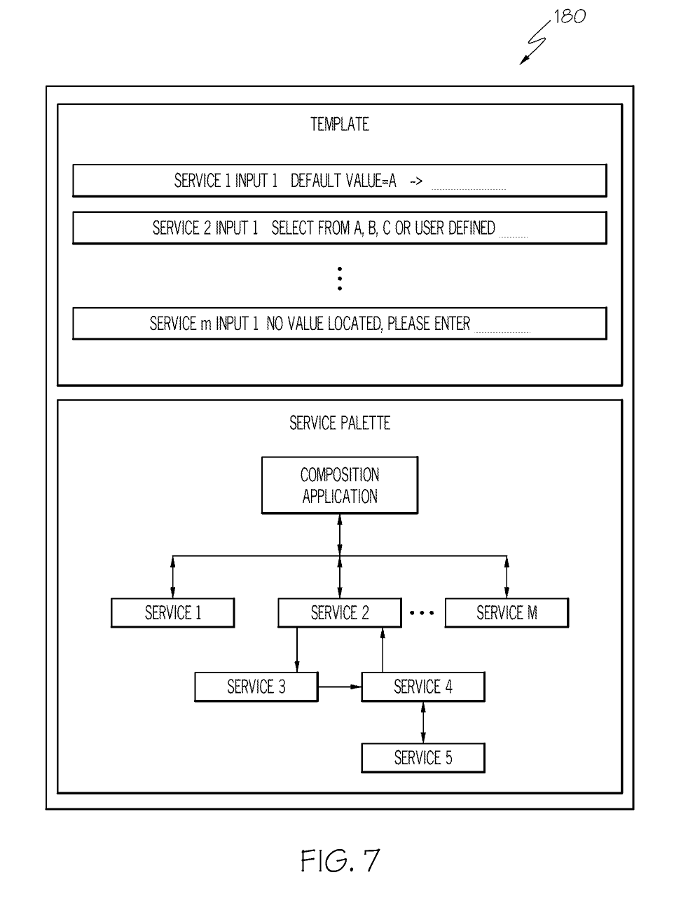

Referring to FIG. 7, an exemplary second interface illustrates a template or other form that presents a dialog to the user to select, correct and/or provide necessary information in order to configure the selected services. For purposes of illustration, in the simplified example, the analysis engine was able to determine a candidate default value “A” for Service 1, input 1. However, this default is provided as a candidate default value and the user is given the opportunity to correct or otherwise change the default selection.

The analysis engine determined multiple alternative candidate inputs for the first input of Service 2. As such, the user may confirm one of the candidate inputs selected by the system; the user may select one of the candidate inputs, or enter a new input. As yet a further illustrative example, the analysis engine was unable to determine a default value for the first input of Service m. As such, the user is given the opportunity to provide the missing information.

Moreover, as shown the selected service has been “wired” or otherwise connected automatically by the analysis engine. As such, the user needs not understand how to join the selected services. Rather, the user merely identifies and selects the services corresponding to the desired task to be automated, e.g., perform patient check-out; schedule next appointment, processes insurance claim, print a summary sheet, etc. and the scripting tool 108 deals with figuring out the assembly of the selected component services.

Thus, keeping with the above-example, the dental receptionist may have utilized the scripting tool 108 to build a script for checking out a patient. At the end of a dentist's visit, the patient walks to the receptionist. The receptionist initiates a suitable script, e.g., by interacting with the script execution mode 122 of the scripting tool 108. In use, the dental receptionist inputs the patient's operation code and asks if the patient has any information updates such as the insurance policy, the credit card for payment, and the FSA account, etc.

If no updates are provided from the patient, the dental receptionist may click a “GO” button or other task automation execution initiation command, e.g., on a visual scripting tool user interface to start executing those tasks. The patient will be charged for her/his co-payment, next appointment will be scheduled based on the patient's default preference, a claim will be filed to the patient's insurance company, and a form will be submitted to the patient's FSA. Finally, a summary report is printed out and given to the patient for a hardcopy record. All such tasks can be constructed from assemblies of web services, where the dental receptionist needs only to understand the underlying processes and information flows, and where the receptionist is able to collect corresponding services onto the workspace. However, the dental receptionist may not have a technical background with regard to traditional application building.

It is possible that a given composition application built by the scripting tool 108 may be capable of performing a defined aspect of its corresponding task using any one of a number of services 114 or combinations of services 114. As such, the analysis engine may recommend that the user choose a service or group of services that are different from the services selected by the user. Again, such recommendations may be based upon historical information and other knowledge, e.g., as stored in the system knowledge 110. Moreover, the selection of the optimal and/or preferred services 114 may change over time. For example, a cost or other utilized service metric may change over time, a service 114 may be revised so as to become more efficient, changes in a corresponding business process may cause a modification to a preference for a given composition application, etc. The analysis engine may recognize these and other like conditions and automatically replace and/or recommend replacement services to those selected by the user. The user may thus decide whether to select the suggested replacement service, or to use the previously selected service.

For example, although a first composition application is built utilizing Service A, Service B and Service C to implement its corresponding business process, there may be multiple alternative candidate services 114 and/or candidate services combinations that may be utilized by the first application. Moreover, there need not be a direct one-to-one between the subparts of a task corresponding to the first application and its corresponding selected services 114. As an example, the role performed by Service A in the first application may be replaced by the combination of Service D and Service E. Likewise, it may be possible to replace both of Service B and Service C with a single service 114, e.g., Service F.

As yet a further example, it is possible that a first user may execute the business process implemented by the first application in a manner that utilizes Service A, but a second user may execute a task corresponding to the same business process in a manner that utilizes a different service 114 or combination of services 110 in place of Service A. As such, at any given time, each service 114, such as in the set of services Service A-Service N, may be unused by the various composition applications built by the scripting tool. Alternatively, a service 110 may be used by one or more of composition applications. Still further, the candidate defaults selected by the scripting tool 108 for a given service may change from user to user, even if the users select the same services onto the palette. Further, from time to time, new services 114 may be added and/or existing services 114 may be removed from automated tasks, such as to accommodate changes in the associated business processes or tasks.

Still further, the services 114 may be originated from third parties, from resources within a corresponding enterprise or otherwise provided within a community of users. Thus, the various services 114 of a given composition application may reside on the same physical device, e.g., a business server, or the services 114 may be distributed across one or more devices, e.g., on one or more business servers within a corresponding organizations computer enterprise, provided by a third party or otherwise distributed across the network system 104.

The present invention is described with reference to flowchart illustrations and/or block diagrams of methods, apparatus systems and computer program products according to embodiments of the invention. It will be understood that each block of the flowchart illustrations and/or block diagrams, and combinations of blocks in the flowchart illustrations and/or block diagrams may be implemented by system components or computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention may be practiced on any form of computer system, including a stand alone computer or one or more processors participating on a distributed network of computers. Thus, computer systems programmed with instructions embodying the methods disclosed herein, or computer systems programmed to perform various aspects of the present invention and storage or storing media that store computer readable instructions for converting a general purpose computer into a system based upon the various aspects of the present invention disclosed herein, are also considered to be within the scope of the present invention. Once a computer is programmed to implement the various aspects of the present invention, including the methods of use as set out herein, such computer in effect, becomes a special purpose computer particular to the methods and program structures of this invention. The techniques necessary for this are well known to those skilled in the art of computer systems.

The flowchart and block diagrams in the Figures illustrate the architecture, functionality, and operation of possible implementations of systems, methods and computer program products according to various embodiments of the present invention. In this regard, one or more blocks in the flowchart or block diagrams may represent a component, segment, or portion of code, which comprises one or more executable instructions for implementing the specified logical function(s). In some alternative implementations, the functions noted in the blocks may occur out of the order noted in the figures. For example, two blocks shown in succession may, in fact, be executed substantially concurrently or in the reverse order.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

Having thus described the invention of the present application in detail and by reference to embodiments thereof, it will be apparent that modifications and variations are possible without departing from the scope of the invention defined in the appended claims.

What is claimed is:

1. A computer-implemented method for automating tasks using assemblies of services comprising:
providing an interface component that allows a user to collect services and to place selected services corresponding to a task to be automated onto a workspace;
providing an analysis component that performs an analysis of available data with regard to said selected services when provided on said workspace;
providing a configuration component to automatically configure inputs of said selected services based upon said analysis of available data and without intervention of said user;
providing a dialog component to allow said user to contribute information to configure one or more of said inputs of said selected services; and
providing an output component that outputs a script that is executable to implement said task to be automated.

2. The computer-implemented method according to claim 1, wherein said providing an interface component that allows a user to collect services and to place selected services corresponding to a task to be automated onto a workspace comprises at least one of:
providing a search component that allows said user to search for published services based upon requirements of said task to be automated and to add desired services returned in corresponding search results to said workspace; and
providing a request component that allows said user to submit a request for a new service based upon a predetermined requirement of said task to be automated, to at least one of a register or provider of services and to add said new service to said workspace if a located service is identified corresponding to said request.

3. The computer-implemented method according to claim 1, wherein said providing an interface component that allows a user to collect services and to place selected services corresponding to a task to be automated onto a workspace comprises:
implementing said workspace as a palette; and
configuring said interface component to allow said user to drag and drop said selected web services onto said palette based upon said task.

4. The computer-implemented method according to claim 1, wherein:
said providing an analysis component that performs an analysis of available data with regard to said selected services when provided on said workspace comprises:
configuring said analysis component to examine said selected services and automatically create a data flow graph organizing said selected services in a sequence so as to minimize inputs required to be entered by said user; and
said providing a dialog component to allow said user to contribute information to configure one or more of said inputs of said selected services comprises:
configuring a dialog from said data flow graph having input data value fields with either selection lists of service results or with user inputs needed to satisfy ones of said selected services that could not be automatically determined.

5. The computer-implemented method according to claim 4, wherein said configuring said analysis component to examine said selected services and automatically create a data flow graph organizing said selected services in a sequence so as to minimize inputs required to be entered by said user comprises:
creating said lists in a most likely to least likely order of service results and providing a design mode template that arranges each list as a form, wherein said order is based upon the availability of template defined defaults or historical knowledge of the associated past use.

6. The computer-implemented method according to claim 1, wherein said providing a dialog component to allow said user to contribute information to configure one or more of said inputs of said selected services comprises:
providing a script executable by said user to configure said selected services by allowing said user to specify whether said script steps through each task required by said execution before starting a next task required by said execution to build said executable application, or whether all tasks are executed in an overlapping mode within the constraints of the relationships defined by said data flow graph.

7. The computer-implemented method according to claim 1, wherein said providing a dialog component to allow said user to contribute information to configure one or more of said inputs of said selected services comprises:
providing a script executable by said user, wherein said user may customize said script by setting defaults for service control inputs or by setting services execution constraints by specifying that an input from a first one of said selected services should be taken from an output of a second one of said selected services.

8. The computer-implemented method according to claim 1, wherein said providing a configuration component to automatically configure inputs of said selected services based upon said analysis of available data and without intervention of said user comprises:
analyzing possible patterns based upon past user inputs to suggest candidate inputs for user default values selected when automatically organizing said selected services.
